(19) United States
(12) Patent Application Publication
(10) Pub. No.: US 2020/0385140 A1
(43) Pub. Date: Dec. 10, 2020

(54) MOBILE SYSTEM FOR GENERATING ELECTRICITY FOR AN AIRCRAFT COMPRISING A FUEL CELL

(71) Applicant: SAFRAN POWER UNITS, Toulouse (FR)

(72) Inventors: Matthieu Baron, Moissy-Cramayel (FR); Fabien Boudjemaa, Moissy-Cramayel (FR); Théophile Horde, Moissy-Cramayel (FR); Jean-Baptiste Jollys, Moissy-Cramayel (FR); Romain Razes, Moissy-Cramayel (FR); Robert Vivier, Moissy-Cramayel (FR)

(21) Appl. No.: 16/763,808

(22) PCT Filed: Nov. 13, 2018
(86) PCT No.: PCT/EP2018/081088

§ 371 Date: May 13, 2020

(30) Foreign Application Priority Data
Nov. 14, 2017 (FR) 1760680

(51) Int. Cl. B64D 41/00; B65D 88/14; H01M 8/04082; H01M 8/04014; H01M 8/2475; H01M 8/04119

(52) U.S. Cl. CPC B64D 41/00; B65D 88/14; H01M 8/04201; H01M 2250/20; H01M 8/2475; H01M 8/04156; B64D 2041/005; H01M 8/04014

(57) ABSTRACT

A mobile system for generating electricity, in particular for an aircraft, said generator system comprising a dioxygen source, a dihydrogen source and a fuel cell generating electricity from dioxygen and dihydrogen. The generator system comprises an aircraft container that is configured to be carried in an aircraft and in which the sources and said fuel cell are mounted, the generator system including an electrical connection module electrically connected to the fuel cell and including an electrical connection output port that is configured to be electrically connected to an aircraft so as to supply it with electricity.

### TECHNICAL FIELD

The present invention relates to the field of fuel cells, notably in the aeronautics field, and more particularly targets a system for generating electrical energy for an aircraft comprising a fuel cell.

Conventionally, aircraft enable passengers to be moved from one destination to another. Today, they also make it possible for passengers to work during the flight as at their normal workplace. Indeed, aircraft are equipped with work tables, lighting devices and electrical supply devices for the personal equipment of passengers throughout the flight, notably their portable computers.

In flight, the lighting and electrical supply devices are supplied with electrical energy by the turbine engines enabling the displacement of the aircraft. Yet, before and after the flight, when the aircraft is on the ground, the turbine engines are off in order to limit fuel consumption, noise and the emission of polluting gases. Also, when the aircraft is on the ground, the different electrical devices of the aircraft are no longer supplied with electrical energy by the turbine engines.

To enable passengers to benefit from electricity during these periods in order to work but also to amuse themselves, an aircraft may comprise an auxiliary motor, designated APU (Auxiliary Power Unit), suited to supplying the aircraft with electrical energy when the turbine engines are off. However, this APU is, like the turbine engines, a heat engine that consumes fuel and generates noise, which leads to the aforementioned drawbacks for turbine engines.

An alternative solution consists in connecting the aircraft to the electrical network of the airport in order to supply it directly with electrical energy. To this end, an airport may propose a service of connecting up the aircraft to the electrical network of the airport.

However, this service is not available in all airports, which represents a drawback. Moreover, this service is expensive for airline companies.

There thus exists a need for a system for supplying an aircraft on the ground with electrical energy which is independent of the airport, which has little nuisance and of which the cost is reduced.

### SUMMARY

To this end, the invention relates to a mobile system for generating electrical energy, notably for an aircraft, said system comprising at least one dioxygen source, at least one dihydrogen source, at least one fuel cell, connected to said dioxygen source and to said dihydrogen source, configured to generate electrical energy from dioxygen and dihydrogen.

The generator system is remarkable in that it comprises an aircraft container configured to be transported in an aircraft and wherein are mounted said dioxygen source, said dihydrogen source and said fuel cell, the generator system comprising at least one electrical connection module electrically connected to the fuel cell, the electrical connection module comprising an electrical connection output port configured to be electrically connected to an aircraft in order to supply it with electrical energy.

Thanks to the system according to the invention, it is possible to supply an aircraft with electrical energy when the turbine engines are off thanks to the use of a fuel cell. Such a fuel cell makes it possible to produce energy without consuming fuel and without emitting polluting gases or generating noise. In addition, such a mobile system is external to the aircraft and may thus be used outside of the aircraft when the aircraft is on the ground. In addition, it may be transported by said aircraft in a practical, safe and reliable manner.

Preferably, the container comprises a lower part, the length of which is shorter than its upper part in order that the shape of the container makes it possible to optimise the use by the container of the inner space of the aircraft.

Advantageously, the container comprises at least one cutaway defining at least one inclined lower wall, the electrical connection module extending into an opening formed in said inclined lower wall in order to protect the electrical connection module from shocks and weather.

Preferably, the aircraft container is of the LD1, LD2, LD3, LD6 or LD8 type such as defined by the ATA (Air Transport Association of America) in order to be handled and stored in a manner similar to a conventional container. Further preferably, the container is made at least in part of aluminium in order to have a sufficiently high strength to withstand transport in an aircraft while having limited weight.

Advantageously, the electrical connection module comprises at least one electric cable of which a first end is electrically connected to the fuel cell and of which a second end is connected to an electrical connection output port. Thus, the system may be placed at a distance from the aircraft while being connected thereto by the electric cable, which enables safe use of the fuel cell. Preferably, the electrical connection module comprises a winder of said electric cable in order to limit the bulk of the cable in the container while enabling easy unwinding when an operator has to plug it into the aircraft.

Further preferably, the electrical connection module is connected to a control port of the fuel cell in order to optimise the use of dihydrogen according to the electrical energy needs of the aircraft and thus to optimise the autonomy and the dimensions of the fuel cell.

Preferably, the system comprises a module for recovering water generated by the fuel cell, said recovery module comprising at least one hydraulic connection output port suited to be hydraulically connected to the aircraft. Thus, the water generated by the fuel cell may be extracted and is recovered in the aircraft to be used.

According to an aspect of the invention, the system comprises a module for cooling the fuel cell, said cooling module comprising at least an air inlet and an air outlet formed in the aircraft container in order to enable external air to circulate inside the aircraft container, which makes it possible to extract outside of the aircraft container the heat generated by the fuel cell.

The invention further relates to an assembly of an aircraft comprising an electrical network and at least one generator system such as described previously, the electrical connection output port of the system being connected to the electrical network of the aircraft in order to supply the aircraft with electrical energy when the turbine engines are off.

The invention also relates to a method for supplying an electrical network of an aircraft by means of a generator system such as described previously, the system being inactive and loaded in a storage space of the aircraft, the method comprising a step of unloading the generator system outside of the aircraft, a step of electrical connection of the generator system to the aircraft and a step of activation of the generator system. Thus, the fuel cell switches between a deactivated state during its storage in the aircraft in order to transport the dihydrogen safely, and an active state wherein it produces electrical energy to supply the aircraft when said aircraft is parked. In addition, the fuel cell is started when it is outside of the aircraft in order to optimise safety while it is in use.

Advantageously, the method comprises a step of deactivation of the generator system before loading of the generator system in the aircraft. Thus, the fuel cell is inert when it is transported in an aircraft, which makes it possible to make its transport safe.

### BRIEF DESCRIPTION OF THE DRAWINGS

The invention will be better understood on reading the description that follows, given uniquely as an example, and by referring to the appended drawings in which:

FIG. 1 is a schematic view of an embodiment of the generator system according to the invention,

FIG. 2 is a schematic view of a first embodiment of a container of the generator system according to the invention,

FIG. 3 is a schematic view of a second embodiment of a container of the generator system according to the invention,

FIG. 4 is a schematic view of an aircraft in parked position connected to a generator system according to the invention, and

FIG. 5 is a schematic view of an aircraft in flight wherein is mounted a generator system according to the invention.

It should be noted that the figures set out the invention in a detailed manner for implementing the invention, said figures obviously being able to better define the invention if need be.

### DETAILED DESCRIPTION

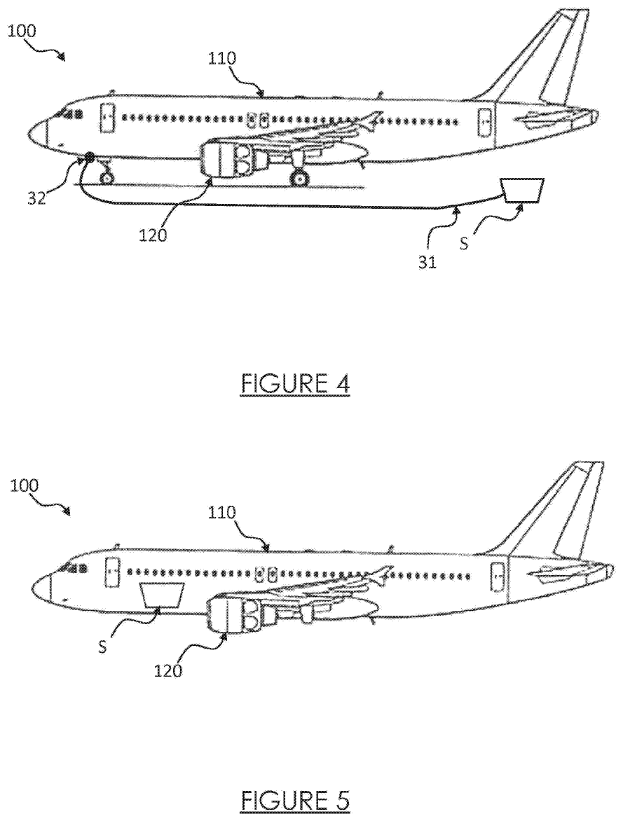

In a known manner, an aircraft 100 is a plane transporting passengers and goods from one destination to another through the air. An aircraft 100 comprises a fuselage 110 forming the body of the aircraft 100 and turbine engines 120 enabling the displacement of the aircraft 100 in the air as illustrated in FIGS. 4 and 5.

The fuselage 110 extends longitudinally and defines, in a general manner, an upper part, called passenger compartment, in which the passengers are situated, and a lower part, called hold, in which may be placed the luggage of the passengers or goods. In a known manner, the aircraft 100 comprises an electrical network for supplying various electrical devices of the passenger compartment (lighting, etc.). The electrical network of the aircraft 100 is supplied with electrical energy by the turbine engines 120 when the aircraft 100 is in flight.

To supply the electrical network of the aircraft 100 on the ground, the invention proposes using a mobile system for generating electrical energy, hereafter designated generator system S, which will now be described.

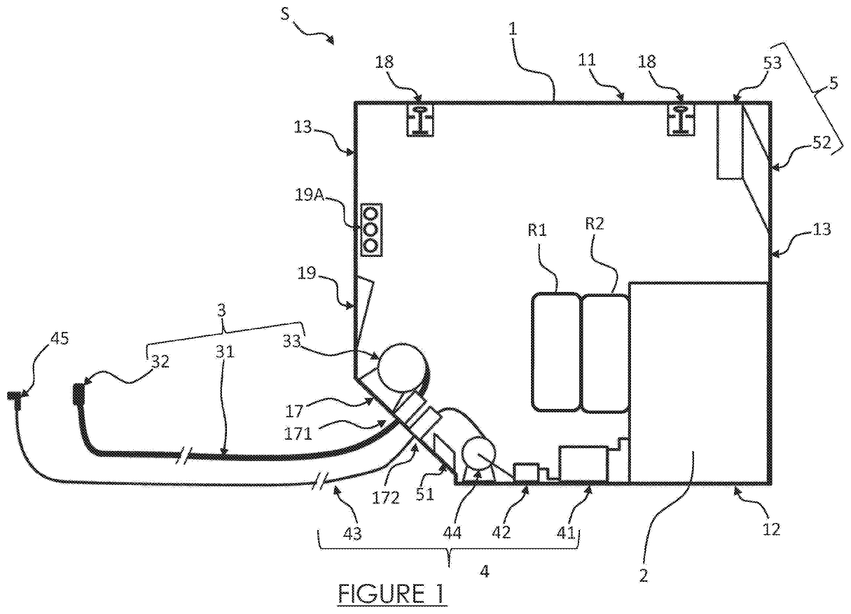

As illustrated in FIG. 1, the generator system S comprises an aircraft container 1 wherein are mounted the other elements of the generator system S, notably a dioxygen source R1, a dihydrogen source R2, a fuel cell 2 supplied by the sources R1, R2. As will be described hereafter, the generator system S also comprises an electrical connection module 3 suited to electrically connect the fuel cell 2 to the electrical network of the aircraft 100, a module for extracting 4 water generated by the fuel cell 2 and a module for cooling 5 the fuel cell 2.

The different elements of the generator system S will now be described in a detailed manner.

The dioxygen source R1 makes it possible to supply dioxygen and is in the form of a tank of dioxygen, a compressor or other. Dioxygen being a gas, it is preferably stored in a pressurised tank in order to store an important quantity of dioxygen molecules, of which the chemical formula is noted O₂, in a reduced volume. Such pressurised storage is also designated hyperbaric storage. In an analogous manner, the dihydrogen source R2 makes it possible to supply dihydrogen and is in the form of a tank of dihydrogen in gaseous or liquid form, a reformer or other. Dihydrogen also being a gas, it is preferably stored in a pressurised dihydrogen tank R2 in order to store an important quantity of dihydrogen molecules, of which the chemical formula is noted H₂, in a reduced volume. Such tanks are known to those skilled in the art and will not be described in greater detail.

In this example, each source R1, R2 is in the form of a tank moveably mounted in the aircraft container 1 in order to enable its replacement by another full tank when it is empty. It goes without saying that each tank R1, R2 could be filled without being removed from the aircraft container 1.

The fuel cell 2 is supplied with dioxygen by the dioxygen source R1 and with dihydrogen by the dihydrogen source R2 in order to generate electrical energy from an electrochemical combustion of dioxygen and dihydrogen. In a known manner, the fuel cell 2 comprises a plurality of cells for making the dioxygen and the dihydrogen react in order to generate electricity thanks to a redox reaction.

In a known manner, each cell comprises an anode and a cathode. At the level of the anode, the dihydrogen dissociates into H⁺ ions and electrons e⁻ according to a reaction given by the formula: 2H₂=4^{H}+4e⁻. The electrons then generate an electric current. At the level of the cathode, H⁺ ions, electrons e⁻ and dioxygen O₂ form water according to a reaction given by the formula: 4H⁺+4e⁻±O₂=2H₂O.

The fuel cell 2 thus makes it possible to generate electrical energy from the reaction between dioxygen and dihydrogen. Such a reaction also produces water and heat which are extracted respectively by the extraction module 4 and by the cooling module 5 as will be described hereafter.

With reference to FIG. 1, the generator system S comprises an aircraft container 1 wherein are stored the other elements in order to protect them. In a known manner, an aircraft container 1 is suited to be transported in the storage hold of the aircraft 100, that is to say, in the lower part of the fuselage.

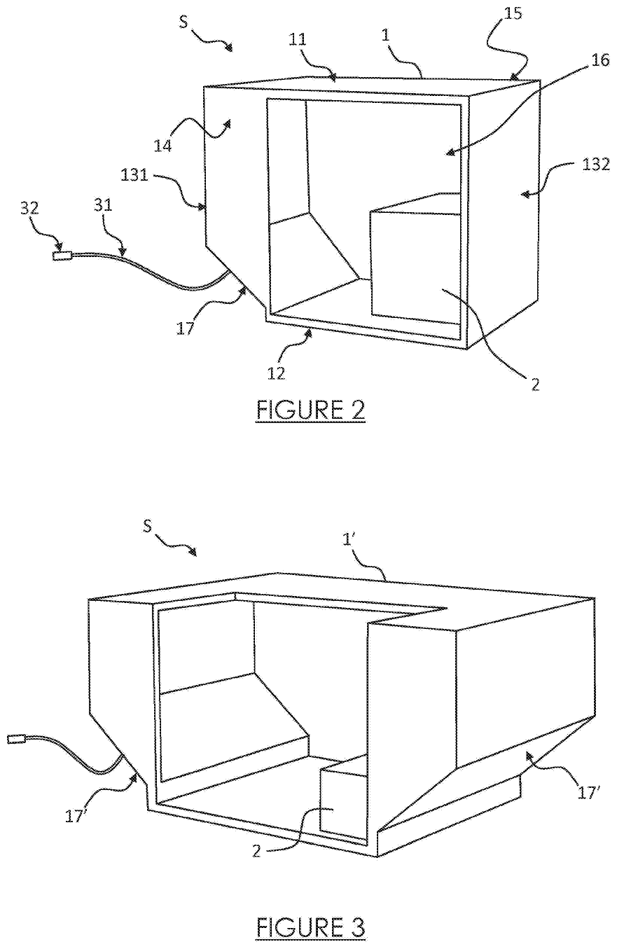

In this first embodiment, with reference to FIG. 2, the aircraft container 1 is in the form of a box having a cutaway. The aircraft container 1 comprises an upper horizonal wall 11, a lower horizontal wall 12, a left vertical wall 131, a right vertical wall 132, a front vertical wall 14 and a rear vertical wall 15. The aircraft container 1 thus defines an inner volume between the different walls, wherein are mounted the different elements of the generator system S. The aircraft container 1 also comprises an opening 16 for accessing the inner volume which is closed by a door or a shutter.

In order to optimise the use of the storage space, the aircraft container 1 comprises an inclined lower wall 17 (cutaway) which allows it to adapt to the shape of the fuselage 110. Indeed, the fuselage 110 has a circular transversal section. Also, the storage hold situated in the lower part has a half-disc shaped section. In other words, the lateral walls of the storage hold are curved and the horizontal length of the transversal section of the storage hold is increasing along the vertical direction. Also, an aircraft container 1 comprising an inclined lower wall 17 makes it possible to limit the bulk in the lower part to adapt to the curved shape of the storage hold. Such an aircraft container 1 comprising an inclined lower wall 17 thus optimises the available volume compared to a parallelepiped container.

In this example, the left vertical wall 131 is shorter than the right vertical wall 132, the inclined lower wall 17 joining the lower horizontal wall 12 to the left vertical wall 131 as illustrated in FIGS. 1 and 2. The aircraft container 1 thus has a lower part of smaller section than its upper part. The aircraft container 1 comprises walls made of metal in order to be robust to withstand shocks and vibrations. With reference to FIG. 2, an aircraft container 1 is represented comprising a single inclined lower wall 17. Such an aircraft container 1 is known by the references LD1, LD2, LD3 such as defined by the ATA (Air Transport Association of America).

With reference to FIG. 3, an aircraft container 1′ is represented comprising two inclined lower walls 17′ (two cutaways) which are laterally opposite. For the sake of clarity and brevity, the second embodiment of the aircraft container 1′ is not described in detail, only differences with the first embodiment are shown. Similarly, analogous numerical references are used.

Such an aircraft container 1′ makes it possible to occupy the entire width of the storage space by adapting to the shape of the fuselage 110 on each side of the aircraft container 1′. Such an aircraft container 1′ is known by its references LD6, LD8 such as defined by the ATA.

As illustrated in FIG. 1, the aircraft container 1 also comprises lifting rings 18 mounted at the level of the upper wall 11 and making it possible to handle the aircraft container 1 with handling equipment of an airport in a conventional manner. The lifting rings 18 are retractable into housings provided in the upper wall 11 in order that, in retracted position, the lifting rings 18 do not extend projecting from the upper wall 11, thus limiting their bulk when they are not used.

With reference to FIG. 1, the aircraft container 1 also comprises a control panel 19 making it possible to control the fuel cell 2 as will be described hereafter as well as indicator lights 19A making it possible to inform an operator of the operating state of the generator system S. In the example illustrated in FIG. 1, the aircraft container 1 comprises three indicator lights 19A corresponding to three states of the generator system S: an active state, a stop state or a fault state.

In practice, if the aircraft 100 has a fault, it sends an error message to the generator system S which then switches to the fault state. The fuel cell 2 then stops producing electrical energy and an indicator light 19A lights up to inform that the fuel cell 2 is in the fault state. Preferably, the control panel 19 also comprises an emergency stop button to command the stoppage of the fuel cell 2.

Optionally, the aircraft container 1 may also comprise wheels (not represented) mounted at the level of the lower horizontal wall 12 in order to facilitate the displacement of the aircraft container 1 on the ground. Such wheels may be retractable in order to limit their bulk when they are not used.

Such an aircraft container 1 advantageously makes it possible to confine the fuel cell in its inner cavity in order to protect the fuel cell 2, notably from shocks and weather, as well as the operator in the event of malfunction of the fuel cell 2.

With reference to FIG. 1, the electrical connection module 3 makes it possible to electrically connect the fuel cell 2 to the aircraft 100 in order to supply the latter with electrical energy produced by the fuel cell 2.

The electrical connection module 3 comprises an electric cable 31 of which a first end (not represented) is connected to the fuel cell 2 and of which a second end is connected to an electrical connection output port 32 making it possible to interface the generator system S with the aircraft 100. In this example, the electrical connection module 3 also comprises a winder 33 configured to wind said electric cable 31 inside the aircraft container 1.

The electric cable 31 comprises at least one supply conductive wire, for example made of a conductive metal material, in order to conduct electrical energy. The supply conductive wire is connected to a supply port of the fuel cell 2.

According to an aspect of the invention, the electric cable 31 also comprises at least one communication conductive wire suited to enabling the exchange of data between the fuel cell 2 and the aircraft 100. The communication conductive wire is connected to a control port of the fuel cell 2. Preferably, the control port of the fuel cell 2 is connected, on the one hand, to the control panel 19 and, on the other hand, to the electrical connection output port 32 via the communication conductive wire. This makes it possible to turn on and turn off the generator system S at a distance in order to regulate the generation of electrical energy by the fuel cell 2 as a function of the needs of the aircraft 100. Thus, the fuel cell 2 produces the necessary quantity of electrical energy to the aircraft 100.

The electrical connection output port 32 makes it possible to cooperate with an electrical connection input port (not represented) of the aircraft 100, such as a parking socket. In this example, the electrical connection output port 32 fulfils a first supply function and a second communication function. As illustrated in FIG. 1, the electric cable 31 is slidingly mounted in a first opening 171 formed in the inclined lower wall 17.

The winder 33, preferably automatic, makes it possible to wind and to unwind the electric cable 31 in order to be able to easily store the electric cable 31 inside the aircraft container 1 while enabling its easy extraction to plug the electrical connection output port 32 to the aircraft 100. Advantageously, the aircraft container 1 comprises a cavity for storing the electrical connection output port 32 when the electric cable 31 is wound. Such a storage cavity makes it possible to protect the electrical connection output port 32 while enabling an operator to take hold of it rapidly and easily in order to unwind the electric cable 31 to plug it into the aircraft 100. Such a storage cavity is situated on the inclined lower wall 17 in order to be easily accessible while limiting the bulk thereof. In wound up storage position, the electrical connection output port 32 is protected by the inclined lower wall 17 against weather and shocks.

In other words, the electrical connection module 3 makes it possible, in the manner of an electric extension cable, to connect the fuel cell 2 to the aircraft 100 while protecting the fuel cell 2. Operators are not in direct contact with the fuel cell 2, which enhances safety.

Still with reference to FIG. 1, the extraction module 4 makes it possible to extract water produced by the fuel cell 2 outside of the aircraft container 1. In this example, the extraction module 4 comprises a water tank 41, an electrical pump 42, a pipe 43 and a winder 44 of said pipe 43.

The water produced by the fuel cell 2 is recovered and stored in the water tank 41. The electrical pump 42 makes it possible to empty the water tank 41 by injecting water into the pipe 43.

The pipe 43 extends longitudinally between a first end connected to the electrical pump 42, and a second end connected to hydraulic connection output port 45.

The hydraulic connection output port 45 may be connected to the aircraft 100 in order to inject water into the aircraft 100 or it could be reused. However, it goes without saying that the hydraulic connection output port 45 could be connected to an external tank. Advantageously, the pipe 43 is flexible in order to be able to be wound and unwound. In a manner analogous to the electric cable 31, the pipe 43 is slidingly mounted in a second opening 172 formed in the inclined lower wall 17.

The winder 44, preferably automatic, makes it possible to wind and to unwind the pipe 43 in order to be able to easily store the pipe 43 inside the aircraft container 1 while enabling its easy extraction to plug the hydraulic connection output port 45 into the aircraft 100. Advantageously, the aircraft container 1 comprises a cavity for storing the hydraulic connection output port 45 when the pipe 43 is wound. Such a storage cavity makes it possible to protect the hydraulic connection output port 45 while enabling an operator to take hold of it in a rapid and easy manner in order to unwind the pipe 43 to plug it into the aircraft 100. Such a storage cavity is situated on the inclined lower wall 17 in order to be easily accessible while protecting it, notably from rain water.

Still with reference to FIG. 1, the cooling module 5 makes it possible to extract heat produced by the fuel cell 2 outside of the aircraft container 1.

The cooling module 5 comprises an air inlet 51, an air outlet 52 and an air fan 53 making it possible for air to flow inside the aircraft container 1 between the air inlet 51 and the air outlet 52. As illustrated in FIG. 1, the air inlet 51 is placed in the lower part of the aircraft container 1 and enables a flow of cold air to enter while enabling a potential extraction of water stored in the bottom of the aircraft container 1. Preferably, the air inlet 51 is formed in the inclined lower wall 17 in order to avoid it being in contact with the ground, which could prevent air from entering.

Still with reference to FIG. 1, the air outlet 52 is placed in the upper part of the aircraft container 1 in order to enable a natural extraction of hot air upwards on account of the difference in density with cold air. In other words, such a position of the air inlet 51 at the bottom and of the air outlet 52 at the top enables a passive circulation of air. The air outlet 52 is preferably in the form of a duct inclined downwards in order to prevent rain water entering into the aircraft container 1. The air inlet 51 and the air outlet 52 are formed on opposite walls of the aircraft container 1 in such a way as to enable optimal ventilation of the inner cavity.

The air fan 53 makes it possible to improve the circulation of air while notably increasing the flow rate of air coming out of the aircraft container 1. Preferably, the fan 53 is mounted in a manner adjacent to the air outlet 52 in order to draw up the inner air. The fan 53 makes it possible to accelerate thermal exchanges with the fuel cell 2 and to optimise the extraction of heat.

According to a preferred aspect, the cooling module 5 also comprises a heat exchanger (not represented) in order to improve heat exchange between the air and the fuel cell 2. Further preferably, a dihydrogen detector is also placed in the aircraft container 1 in order to detect a potential leak of dihydrogen which may be dangerous on account of its flammable character. Such a dihydrogen detector is placed in the upper part of the aircraft container 1 because, dihydrogen being less dense than air, it accumulates in the upper part of the aircraft container 1.

An example of use of the generator system S will now be described.

With reference to FIG. 4, when the aircraft 100 is parked at the level of an airport, the generator system S is positioned near to the aircraft 100. To electrically connect the generator system S to the aircraft 100, an operator takes hold of the electrical connection output port 32, pulls it up to the aircraft 100 while unwinding the electric cable 31, opposing the force of the winder 33, then plugs it into the aircraft 100 to electrically connect the aircraft 100 to the generator system S and to allow them to communicate. In this embodiment, the aircraft 100 may also control the generation of electrical energy by the fuel cell 2 via the electrical connection output port 32.

To hydraulically connect the aircraft 100 to the generator system S, the operator takes hold of the hydraulic connection output port 45, pulls it up to the aircraft 100 while unwinding the pipe 43 then plugs it into the hydraulic network of the aircraft 100. The electrical and hydraulic connection of the generator system S is simple to carry out by a single operator. Moreover, safety conditions are optimal, the operator never being in direct contact with the fuel cell 2.

The operator may command the activation of the fuel cell 2 from the control panel 19 situated on the aircraft container 1. An indicator light 19A then lights up to inform that the fuel cell 2 is in the on state. The fuel cell 2 then generates electrical energy for the aircraft 100. Water generated by the fuel cell 2 is recovered and extracted from the generator system S by the pipe 43. Heat generated by the fuel cell 2 is extracted from the generator system S via the air outlet 52.

Preferably, while the fuel cell 2 is in operation, the aircraft 100 sends data to the generator system S in order to control the fuel cell 2 so that said fuel cell generates the necessary electrical power. This makes it possible to adapt the dihydrogen consumption of the fuel cell 2 as a function of the needs of the aircraft 100 and thus to extend the autonomy of the fuel cell 2. This also makes it possible to optimise the dimensioning of the generator system S in order to limit the bulk thereof.

Thanks to the invention, the aircraft 100 is not dependent upon the airport to be supplied electrically. Moreover, the generator system S does not cause a nuisance.

Advantageously, when the aircraft 100 has to go to a new destination, the generator system S may be loaded in the aircraft in order to be able to be used at the new destination. To this end, with reference to FIG. 5, the generator system S is positioned in the storage hold of the aircraft 100 in a manner similar to a conventional aircraft container. The generator system S may be handled in a manner analogous to a conventional container. Advantageously, the connection ports 32, 45 are protected against lateral and vertical shocks during transport on account of their positioning under the inclined lower surface 17.

The generator system S is deactivated in order to enable the safe transport of dihydrogen. To do so, the fuel cell 2 is inactivated, in other words, it no longer generates electrical energy. An indicator light 19A lights up to inform an operator that the fuel cell 2 is in the stop state. Thus, in flight, the system for generating S electrical energy does not interact with the aircraft 100, which makes it possible to dispense with an authorisation of the constructor of the aircraft 100.

Once arrived at the new destination, the generator system S is unloaded from the aircraft 100 then once again connected to the electrical network of the aircraft 100 in order to supply it electrically. The generator system S according to the invention makes it possible to ensure an electrical supply of the aircraft in a mobile manner while ensuring high safety.

1-10. (canceled)

11. A mobile system for generating electrical energy, notably for an aircraft, said generator system comprising:
at least one dioxygen source;
at least one dihydrogen source;
at least one fuel cell, connected to said dioxygen source and to said dihydrogen source, configured to generate electrical energy from dioxygen and dihydrogen,
said generator system comprising an aircraft container adapted to be transported in an aircraft and wherein are mounted said dioxygen source, said dihydrogen source and said fuel cell, the generator system comprising at least one electrical connection module electrically connected to the fuel cell, the electrical connection module comprising an electrical connection output port configured to be electrically connected to an aircraft in order to supply it with electrical energy.

12. The generator system according to claim 11, wherein the container comprises a lower part, the length of which is shorter than its upper part.

13. The generator system according to claim 11, wherein the container comprises at least one cutaway defining at least one inclined lower wall, the electrical connection module extending into an opening formed in said inclined lower wall.

14. The generator system according to claim 13, wherein the aircraft container is of the LD1, LD2, LD3, LD6 or LD8 type such as defined by the ATA (Air Transport Association of America).

15. The generator system according to claim 14, wherein the electrical connection module comprises at least one electric cable of which a first end is electrically connected to the fuel cell and of which a second end is connected to an electrical connection output port.

16. The generator system according to claim 15, wherein the electrical connection module is connected to a control port of the fuel cell.

17. The generator system according to claim 16, wherein the generator system comprises a module for recovering water generated by the fuel cell, said recovery module comprising at least one hydraulic connection output port suited to being hydraulically connected to the aircraft.

18. The generator system according to claim 17, wherein the generator system comprises a module for cooling the fuel cell, said cooling module comprising at least one air inlet and an air outlet formed in the aircraft container.

19. The assembly of an aircraft comprising an electrical network and at least one generator system according to claim 18, the electrical connection output port of the generator system being connected to the electrical network of the aircraft.

20. The method for supplying an electrical network of an aircraft by means of a generator system according to claim 1, the generator system being inactive and loaded into a storage space of the aircraft, the method comprising:
a step of unloading the generator system outside of the aircraft;
a step of electrical connection of the generator system to the aircraft; and
a step of activation of the generator system.
